(19) United States
(12) Patent Application Publication
(10) Pub. No.: US 2025/0100423 A1
(43) Pub. Date: Mar. 27, 2025

(54) VEHICLE SEAT MOUNTING STRUCTURE

(71) Applicant: TS TECH CO., LTD., Asaka-shi, Saitama (JP)

(72) Inventors: Akira MIYOSHI, Tochigi (JP); Munetaka KOWA, Tochigi (JP)

(21) Appl. No.: 18/848,449

(22) PCT Filed: Apr. 21, 2023
(86) PCT No.: PCT/JP2023/015882

§ 371 Date: Sep. 18, 2024

Related U.S. Application Data
(60) Provisional application No. 63/363,838, filed on Apr. 29, 2022.
(60) Provisional application No. 63/345,925, filed on May 26, 2022.

(30) Foreign Application Priority Data
Apr. 17, 2023 (JP) 2023-066961

(51) Int. Cl. B60N 2/015; B60K 1/04; B60N 2/06; B60N 2/14

(52) U.S. Cl. CPC B60N 2/015; B60K 1/04; B60N 2/06; B60N 2/14; B60K 2001/0405

(57) ABSTRACT

The vehicle seat mounting structure includes a floor, a battery case provided on the floor and housing a battery, a seat connected to the floor via a plurality of support legs and positioned above the battery case, and a reinforcing structure provided on a top side of the battery case and connected to the seat.

### TECHNICAL FIELD

The present invention relates to a vehicle seat mounting structure.

### BACKGROUND ART

Patent Document 1 discloses a vehicle seat mounting structure including a battery case attached to the upper surface of a floor and housing a battery therein, a plurality of support legs connected to the upper surface of the floor and extending upward, a plurality of seat rails connected to the upper ends of the support legs, and a rear seat supported by the seat rails. According to this mounting structure, the battery case can be placed under the seat with a good space efficiency.

### PRIOR ART DOCUMENT(S)

### Patent Document(s)

Patent Document 1: JP2020-111168A

### SUMMARY OF THE INVENTION

### Task to be Accomplished by the Invention

However, in this mounting structure, since the seat is positioned above the battery case, each support leg is required to be vertically elongated with the result that the stability of the seat may be impaired.

In view of the above background, a primary object of the present invention is to provide a vehicle seat mounting structure that allows a seat to be supported above a battery case in a stable manner.

### SOLUTION FOR ACCOMPLISHING THE TASK

In order to accomplish such a task, an aspect of the present invention provides a vehicle seat mounting structure (1), comprising: a floor (2); a battery case (16) provided on the floor and housing a battery (15); a seat (30) connected to the floor via a plurality of support legs (27) and positioned above the battery case; and a reinforcing structure (25) provided on a top side of the battery case and connected to the seat.

According to this aspect, since the seat is supported by the battery case via the reinforcing structure in this vehicle seat mounting structure, the seat can be supported above the battery case in a stable manner. Since the rigidity of the battery case is improved by the reinforcing structure, the battery case can support the seat in a stable manner.

In the above aspect, preferably, the reinforcing structure includes a plurality of reinforcing members (25A to 25C) extending along an upper surface of the battery case and connected to one another, the reinforcing members having a frame structure when viewed from above.

According to this aspect, the reinforcing structure can efficiently reinforce the upper surface of the battery case.

In the above aspect, preferably, the reinforcing members include a left and a right first member (25A) that extend in a fore and aft direction, a second member (25B) that extends in a lateral direction and is connected between front ends of the left and right first members, and a third member (25C) that extends in the lateral direction and is connected between the rear ends of the left and right first members, and the front and rear ends of the first members are connected to the seat.

According to this aspect, the reinforcing structure can support the seat with a good stability.

In the above aspect, preferably, at least a part of the battery overlaps with the reinforcing structure when viewed from above.

According to this aspect, the battery and the reinforcing structure can be efficiently arranged under the seat.

In the above aspect, preferably, the support legs are connected to the seat and the reinforcing structure.

According to this aspect, the reinforcing structure can improve the rigidity of the support legs.

In the above aspect, preferably, the seat includes a seat main body and a slide device (36) provided under the seat main body, and the reinforcing structure and the support legs are connected to the slide device.

According to this aspect, the seat can be slidably supported above the battery case.

In the above aspect, preferably, the seat includes a rotation device (37) interposed between the seat main body and the slide device, and at least a part of the rotation device overlaps with the reinforcing structure when viewed from above.

According to this aspect, the seat can be rotatably supported above the battery case.

In the above embodiment, preferably, an electronic control device (53) is provided inside the reinforcing structure when viewed from above.

According to this aspect, the electronic control device can be arranged with a good space efficiency by utilizing the space inside the reinforcing structure. In the above aspect, preferably, the electronic control device is positioned on the upper surface of the battery case.

According to this aspect, the electronic control device can be positioned with a good space efficiency by utilizing the space between the battery case and the seat. In the above aspect, preferably, the battery at least partly overlaps with the electronic control device when viewed from above.

According to this aspect, the electronic control device can be positioned between the seat and the battery with a good space efficiency.

### Effect of the Invention

In order to accomplish such a task, an aspect of the present invention provides a vehicle seat mounting structure (1), comprising: a floor (2); a battery case (16) provided on the floor and housing a battery (15); a seat (30) connected to the floor via a plurality of support legs (27) and positioned above the battery case; and a reinforcing structure (25) provided on a top side of the battery case and connected to the seat.

According to this aspect, since the seat is supported by the battery case via the reinforcing structure in this vehicle seat mounting structure, the seat can be supported above the battery case in a stable manner. Since the rigidity of the battery case is improved by the reinforcing structure, the battery case can support the seat in a stable manner.

In the above aspect, preferably, the reinforcing structure includes a plurality of reinforcing members (25A to 25C) extending along an upper surface of the battery case and connected to one another, the reinforcing members having a frame structure when viewed from above.

According to this aspect, the reinforcing structure can efficiently reinforce the upper surface of the battery case.

In the above aspect, preferably, the reinforcing members include a left and a right first member (25A) that extend in a fore and aft direction, a second member (25B) that extends in a lateral direction and is connected between front ends of the left and right first members, and a third member (25C) that extends in the lateral direction and is connected between the rear ends of the left and right first members, and the front and rear ends of the first members are connected to the seat.

According to this aspect, the reinforcing structure can support the seat with a good stability.

In the above aspect, preferably, at least a part of the battery overlaps with the reinforcing structure when viewed from above.

According to this aspect, the battery and the reinforcing structure can be efficiently arranged under the seat.

In the above aspect, preferably, the support legs are connected to the seat and the reinforcing structure.

According to this aspect, the reinforcing structure can improve the rigidity of the support legs.

In the above aspect, preferably, the seat includes a seat main body and a slide device (36) provided under the seat main body, and the reinforcing structure and the support legs are connected to the slide device.

According to this aspect, the seat can be slidably supported above the battery case.

In the above aspect, preferably, the seat includes a rotation device (37) interposed between the seat main body and the slide device, and at least a part of the rotation device overlaps with the reinforcing structure when viewed from above.

According to this aspect, the seat can be rotatably supported above the battery case.

In the above embodiment, preferably, an electronic control device (53) is provided inside the reinforcing structure when viewed from above.

According to this aspect, the electronic control device can be arranged with a good space efficiency by utilizing the space inside the reinforcing structure. In the above aspect, preferably, the electronic control device is positioned on the upper surface of the battery case.

According to this aspect, the electronic control device can be positioned with a good space efficiency by utilizing the space between the battery case and the seat. In the above aspect, preferably, the battery at least partly overlaps with the electronic control device when viewed from above.

According to this aspect, the electronic control device can be positioned between the seat and the battery with a good space efficiency.

### BRIEF DESCRIPTION OF THE DRAWINGS

FIG. 1 is a sectional view of a vehicle seat mounting structure according to an embodiment of the present invention;

FIG. 2 is a horizontal sectional view of the vehicle seat mounting structure;

FIG. 3 is a diagram illustrating the positioning of the seat and the battery case;

FIG. 4 is a sectional view showing a modification of the vehicle seat;

FIG. 5 is a sectional view showing another modification of the vehicle seat;

FIG. 6 is a sectional view showing yet another modification of the vehicle seat;

FIG. 7 is a sectional front view showing a modification of the vehicle seat mounting structure;

FIG. 8 is a sectional front view showing another modification of the vehicle seat mounting structure;

FIG. 9 is a sectional front view showing yet another modification of the vehicle seat mounting structure;

FIG. 10 is a sectional front view showing yet another modification of the vehicle seat mounting structure;

FIG. 11 is a sectional side view showing a modification of the vehicle seat mounting structure;

FIG. 12 is a sectional side view showing another modification of the vehicle seat mounting structure;

FIG. 13 is a sectional side view showing yet another modification of the vehicle seat mounting structure;

FIG. 14 is a sectional side view showing yet another modification of the vehicle seat mounting structure;

FIG. 15 is a sectional front view of a vehicle seat mounting structure according to yet another embodiment of the present invention;

FIG. 16 is a sectional front view of a vehicle seat mounting structure according to yet another embodiment of the present invention;

FIG. 17 is a sectional side view of a vehicle seat mounting structure according to yet another embodiment of the present invention;

FIG. 18 is a diagram illustrating a vehicle temperature control system according to yet another embodiment of the present invention; and

FIG. 19 is a flowchart showing the temperature control process of this other embodiment.

### DESCRIPTION OF THE PREFERRED EMBODIMENT(S)

A vehicle seat mounting structure according to an embodiment of the present invention will be described in the following with reference to the appended drawings. The vehicle may be an automobile such as a one-box car.

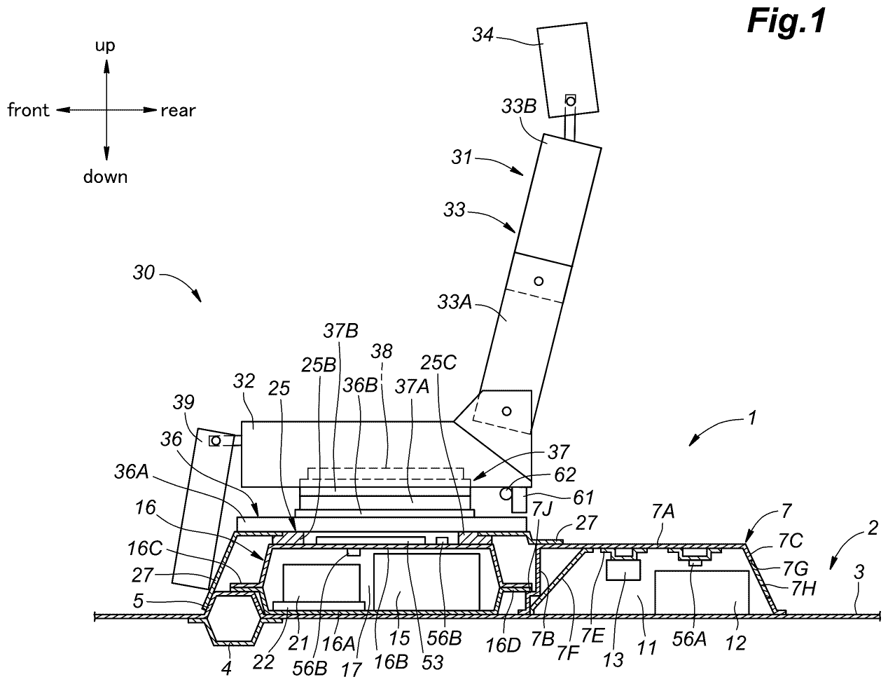

As shown in FIG. 1, the vehicle seat mounting structure 1 includes a floor 2. The floor 2 includes a floor panel 3 in a plate form and a plurality of cross members 4 connected to the floor panel 3. A pair of side sills extend longitudinally and are connected to either side edge of the floor panel 3. The cross members 4 extend laterally at intervals in the fore and aft direction. The two ends of each cross member 4 are coupled to the corresponding side sills on either side.

The cross members 4 may be connected to the lower surface or the upper surface of the floor panel 3. Further, the cross members 4 are each preferably formed in a channel shape so as to form a closed cross-section structure in cooperation with the floor panel 3. In this embodiment, each cross member 4 is connected to the lower surface of the floor panel 3. The floor panel 3 is provided with a convex portion 5 projecting upward in a part thereof corresponding to one of the cross members 4. The convex portion 5 extends laterally along the cross member 4. The convex portion 5 improves the rigidity of the floor panel 3.

A floor box 7 is provided on the upper surface of the floor panel 3. The floor box 7 is positioned at a distance rearward from the convex portion 5. The floor box 7 includes an upper wall 7A which faces vertically, a front wall 7B which extends downward from the front edge of the upper wall 7A and faces in the fore and aft direction, a rear wall 7C which extends downward from the rear edge of the upper wall 7A and faces in the fore and aft direction, and a pair of side walls 7D which extend downward from the left and right side edges of the upper wall 7A, respectively, and face laterally. The front edges of the left and right side walls 7D are joined to the left and right side edges of the front wall 7B, respectively. The rear edges of the left and right side walls 7D are joined to the left and right side edges of the rear wall 7C, respectively. The floor box 7 is formed into a box shape that opens downward. The lower edges of the front wall 7B, the lower edge of the rear wall 7C and the left and right side walls 7D are connected to the upper surface of the floor panel 3. The floor panel 3 and the floor box 7 are preferably formed of sheet metal.

The floor box 7 is preferably formed of sheet steel or a resin material. The floor box 7 forms a part of the floor 2 in cooperation with the floor panel 3. A floor storage chamber 11 for storing articles is formed between the floor box 7 and the floor panel 3. For example, the floor storage chamber 11 houses a first battery 12. In other embodiments, other items such as tires and tools may be stored in the floor storage chamber 11 instead of the first battery 12. Further, the floor storage chamber 11 is preferably provided with a fan 13 for cooling the first battery 12 stored therein. The floor box 7 is preferably provided with a plurality of ventilation holes consisting of through holes.

The floor box 7 is provided with a plurality of reinforcing members 7E. The reinforcing members 7E may include, for example, channel members extending laterally and connected to the lower surface of the upper wall 7A. Further, the reinforcing members 7E may include a brace 7F that extends upward from the lower end of the front wall 7B and is connected to the lower surface of the upper wall 7A. A fan 13 is preferably attached to one of the reinforcing members 7E.

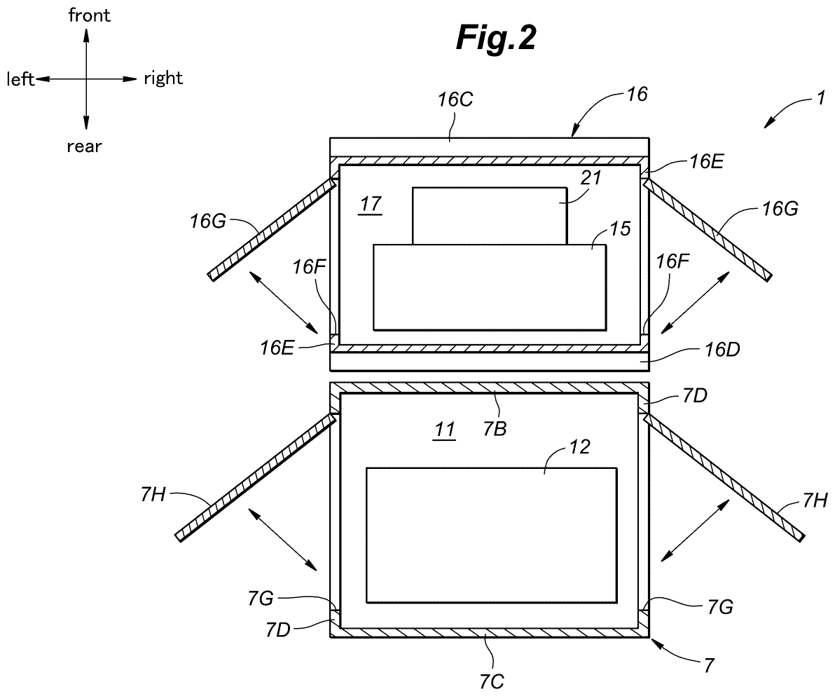

As shown in FIGS. 1 and 2, an opening 7G is formed in at least one of the upper wall 7A, the rear wall 7C, and the left and right side walls 7D. The opening 7G is provided with a lid 7H that opens and closes the opening 7G. The lid 7H may be connected to the rear wall 7C, the upper wall 7A, the left side wall or the right side wall 7D, for example, via a hinge. An opening 7G may be formed in the floor panel 3. In this case, the lid 7H may be connected to the floor panel 3 via a hinge. The first battery 12 can be taken into and out of the floor storage chamber 11 via the opening 7G.

As shown in FIG. 1, a shoulder surface 7J facing in the vertical direction is formed at a vertically intermediate part of the front wall 7B. The lower part of the front wall 7B projects forward relative to an upper part of the front wall 7B.

A battery case 16 that accommodates a second battery 15 is provided on the floor 2. The first battery 12 and the second battery 15 may each consist of a battery that supplies power to a drive source of the vehicle, or a battery that supplies power to an electric device such as an electronic control device or a navigation system.

The battery case 16 is formed into a box shape by combining a lower case part 16A and a upper case part 16B. A front fastening portion 16C that protrudes forward is provided at the front end of the battery case 16. A rear fastening portion 16D that projects rearward is provided at the rear end of the battery case 16. The front fastening portion 16C is formed by a flange provided at the front edge of the lower case part 16A and a flange provided at the front edge of the upper case part 16B. The rear fastening portion 16D is formed by a flange provided at the rear edge of the lower case part 16A and a flange provided at the rear edge of the upper case part 16B. A left and a right end wall 16E facing laterally are preferably provided on the left and right sides, respectively, of each of the lower case part 16A and the upper case part 16B. A case housing chamber 17 for housing the second battery 15 is formed between the lower case part 16A and the upper case part 16B. The battery case 16 is preferably formed of sheet steel or a resin material.

The battery case 16 is preferably connected to the floor 2. Specifically, the battery case 16 is preferably connected to at least one of the floor panel 3, the cross members 4 and the floor box 7. The battery case 16 may be fastened to the floor 2 with fastening members such as bolts and nuts, or may be welded to the floor 2. In this embodiment, the battery case 16 is placed on the upper surface of the floor panel 3. The lower surface of the battery case 16 may be connected to the upper surface of the floor panel 3. The front fastening portion 16C is connected to the upper surface of the convex portion 5, and the rear fastening portion 16D is connected to the shoulder surface 7J of the floor box 7. The battery case 16 is positioned between the cross member 4 and the floor box 7 in the fore and aft direction.

In another embodiment, at least one reinforcing member extending laterally may be provided on the upper surface of the floor panel 3, and the lower surface of the battery case 16 may be connected to the reinforcing member.

As shown in FIG. 2, the battery case 16 has an opening 16F formed therein. The opening 16F is provided with a lid 16G that opens and closes the opening 16F. The lid 16G may be connected to the battery case 16, for example, via a hinge. In this embodiment, the opening 16F is formed in each of the lateral end walls 16E of the battery case 16. Thus, the second battery can be taken in and out of the battery housing section through the opening 16F.

As shown in FIG. 1, the second battery 15 may be placed at any position in the case housing chamber 17. A plurality of ventilation holes consisting of through holes are formed in the battery case 16. A fan 21 may be placed inside the battery case 16. The fan 21 draws air into the battery case 16 through the ventilation holes to cool the second battery 15. A support member 22 for supporting the fan 21 may be provided in the case housing chamber 17. The support member 22 is preferably flexible and has a function of absorbing shocks applied to the fan 21. A support member 22 may also be provided under the second battery 15. In this embodiment, the second battery 15 is positioned at the rear of the case housing chamber 17, the support member 22 is positioned at the front of the second battery 15, and the fan 21 is supported on the upper surface of the support member 22.

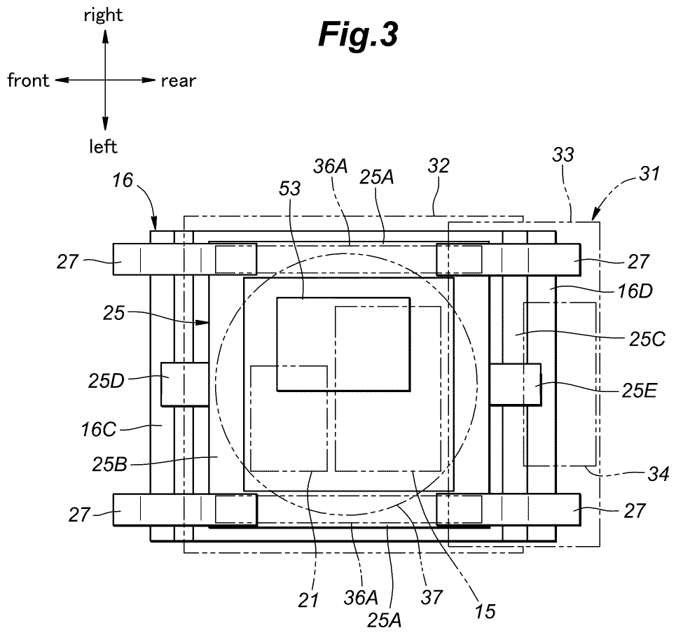

As shown in FIG. 3, a reinforcing structure 25 is provided on the upper surface of the battery case 16. The reinforcing structure 25 extends along the upper surface of the battery case 16 and includes a plurality of reinforcing members 25A to 25C connected to each other. The reinforcing structure 25 is preferably formed of a channel-shaped steel material, for example. The reinforcing members 25A to 25C are preferably formed into a frame shape when viewed from above. The reinforcing members 25A to 25C include a left and a right first member 25A extending in the fore and aft direction, a second member 25B extending laterally and connected between the front ends of the left and right first members 25A, and a third member 25° C. extending laterally and connected between the rear ends of the left and right first members 25A. Thus, the reinforcing structure 25 is formed into a rectangular shape when viewed from above. Thereby, the reinforcing structure 25 can efficiently reinforce the upper surface of the battery case 16.

The reinforcing structure 25 may further include a reinforcing member 25D extending from the second member 25B to the front fastening portion 16C along the upper surface of the battery case 16. Further, the reinforcing structure 25 may further include a reinforcing member 25E extending from the third member 25C to the rear fastening portion 16D along the upper surface of the battery case 16. A plurality of reinforcing beads may be formed on the surface of the battery case 16.

As shown in FIG. 1, a seat 30 is placed on the battery case 16 via a plurality of support legs 27. The seat 30 includes a seat main body 31 for seating an occupant. The seat main body 31 includes a seat cushion 32 that supports the buttocks of the occupant from below, a seat back 33 that is rotatably supported by the seat cushion 32 and supports the back of the occupant, and a headrest provided at the upper end of the seat back 33 to support the head of the occupant. The seat 30 also includes a slide device 36 provided at the bottom of the seat main body 31 and a rotation device 37 interposed between the seat main body 31 and the slide device 36.

A height adjustment device 38 for changing the height of the seat cushion 32 may be provided between the rotation device 37 and the seat cushion 32. The height adjustment device 38 may be formed, for example, by a link mechanism. An ottoman 39 may be rotatably provided at the front end of the seat cushion 32. The slide device 36, the rotation device 37, the height adjustment device 38, and the ottoman 39 are not essential components of the seat 30 and may be omitted in other embodiments.

The seat back 33 may include a lower seat back 33A rotatably supported by the seat cushion 32 and an upper seat back 33B rotatably supported by the lower seat back 33A. The headrest 34 is rotatably supported by the seat back 33.

The slide device 36 includes a left and a right lower rail 36A that extend in the fore and aft direction, and a left and a right upper rail 36B that are slidably supported by the left and right lower rails 36A, respectively.

The support legs 27 are connected to the slide device 36. The support legs 27 are four in number so as to correspond to the front and rear ends of the left and right lower rails 36A. Each support leg 27 extends vertically and is connected to the floor 2 at its lower end and to the front or rear end of the corresponding lower rail 36A at its upper end. In this embodiment, the two front support legs 27 which are connected to the front ends of the left and right lower rails 36A are connected to the convex portion 5 at their lower ends. Further, the rear support legs 27 connected to the rear ends of the left and right lower rails 36A are connected to the upper wall 7A of the floor box 7 at their lower ends. The lower end of each support leg 27 may also be fastened to the upper surface of the floor panel 3.

Further, the reinforcing structure 25 is connected to the left and right lower rails 36A of the seat 30. For example, the front and rear ends of each first member 25A may be connected to the front and rear ends of the corresponding lower rail 36A of the seat 30. Further, the reinforcing structure 25 is preferably connected to the support legs 27. For example, the upper end of each support leg 27 may be positioned vertically between the first member 25A and the lower rail 36A. Further, the upper end of each support leg 27 may be fastened jointly to the first member 25A and the lower rail 36A. Thereby, the reinforcing structure 25 can improve the rigidity of the support legs 27. Further, the reinforcing structure 25 can support the seat 30 with good stability.

The left and right upper rails 36B are connected to the seat cushion 32 via a rotation device 37. The rotation device 37 includes a base plate 37A connected to the left and right upper rails 36B, and a rotating plate 37B rotatably supported on the upper surface of the base plate 37A about a vertical axis. The rotating plate 37B is connected to the seat cushion 32 via the height adjustment device 38. The base plate 37A and the rotating plate 37B are each formed into a plate shape, and vertically overlap with each other. A thrust bearing is preferably provided between the base plate 37A and the rotating plate 37B. As shown in FIG. 3, at least a part of the rotation device 37 preferably overlaps with the reinforcing structure 25 when viewed from above.

As shown in FIG. 1, an electronic control device 53 is placed inside the reinforcing structure 25 when viewed from above. The electronic control device 53 is positioned on the top surface of the battery case 16. According to this embodiment, the electronic control device 53 can be placed with a good space efficiency by utilizing the space inside the reinforcing structure 25. Moreover, the electronic control device 53 can be placed with a good space efficiency by utilizing the space between the battery case 16 and the seat 30.

The electronic control device 53 includes a processor such as a CPU, nonvolatile memory (ROM), volatile memory (RAM), and the like. The electronic control device 53 controls a plurality of electric devices provided on the seat 30 by causing the processor to execute arithmetic processing in accordance with a program stored in the nonvolatile memory. The electric devices may include, for example, an electric motor of the slide device 36, an electric motor of the rotation device 37, an electric motor of the height adjustment device 38, seat heaters provided in the seat cushion 32 and the seat back 33, a blower, and various sensors.

The sensors may include a first sensor 56A that detects the temperature of the floor storage chamber 11 and the temperature of the first battery 12 placed in the floor storage chamber 11. The first sensor 56A may also detect the humidity within the first battery 12 or the floor storage chamber 11. The first sensor 56A may be provided on any one of the inner surface of the floor box 7, the reinforcing member 7E of the floor box 7, and the lid 7H. Further, the first sensor 56A may be provided directly on the first battery 12.

The sensors may further include a second sensor 56B that detects the temperature of the second battery 15 or the case housing chamber 17. The second sensor 56B may also detect the humidity of the second battery 15 or the case housing chamber 17. The second sensor 56B may be provided on the inner surface of the battery case 16 or on the outer surface of the battery case 16. Further, the second sensor 56B may be provided directly on the second battery 15 within the battery case 16.

As shown in FIG. 3, at least a part of the second battery 15 preferably overlaps with the reinforcing structure 25 when viewed from above. Further, it is preferable that at least a part of the second battery 15 overlaps with the electronic control device 53 when viewed from above. According to this embodiment, the electronic control device 53 can be arranged between the seat 30 and the second battery 15 with a good space efficiency.

As shown in FIG. 1, a cover 61 may be provided at the bottom of the seat cushion 32 to conceal the rotation device 37 and the height adjustment device 38. The cover 61 preferably projects downward from the rear end of the seat cushion 32 and extends laterally. A wire harness 62 that connects the electric devices of the seat 30 to the electronic control device 53 is preferably supported on the back surface of the cover 61.

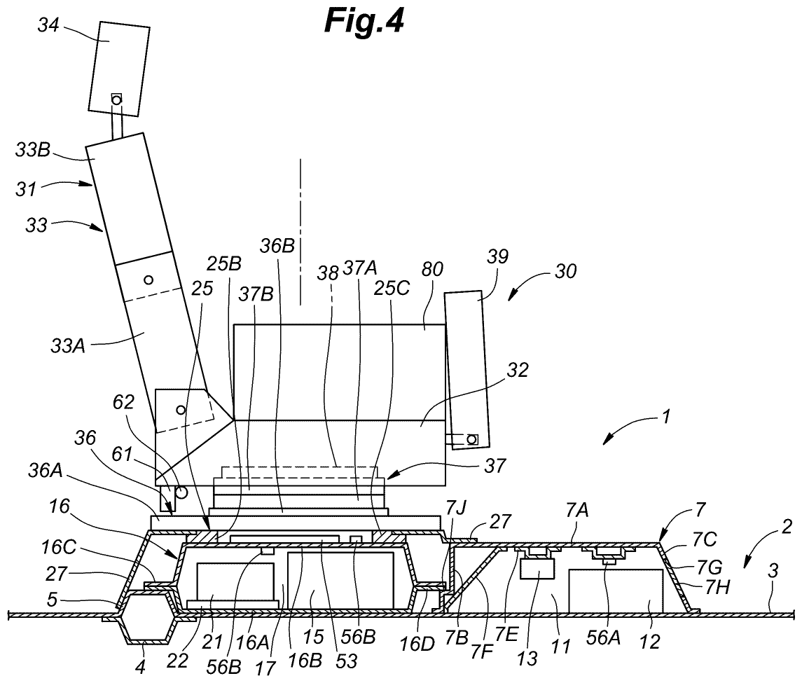

As shown in FIG. 4, the ottoman 39 can take an upright position extending upward from the seat cushion 32. When the ottoman 39 is in the upright position, the ottoman 39 and the seat back 33 can support the luggage 80 placed on the upper surface of the seat cushion 32 in the fore and aft direction. In FIG. 4, the seat main body 31 faces rearward on account of the rotation device 37 rotating the seat main body 31 by 180 degrees.

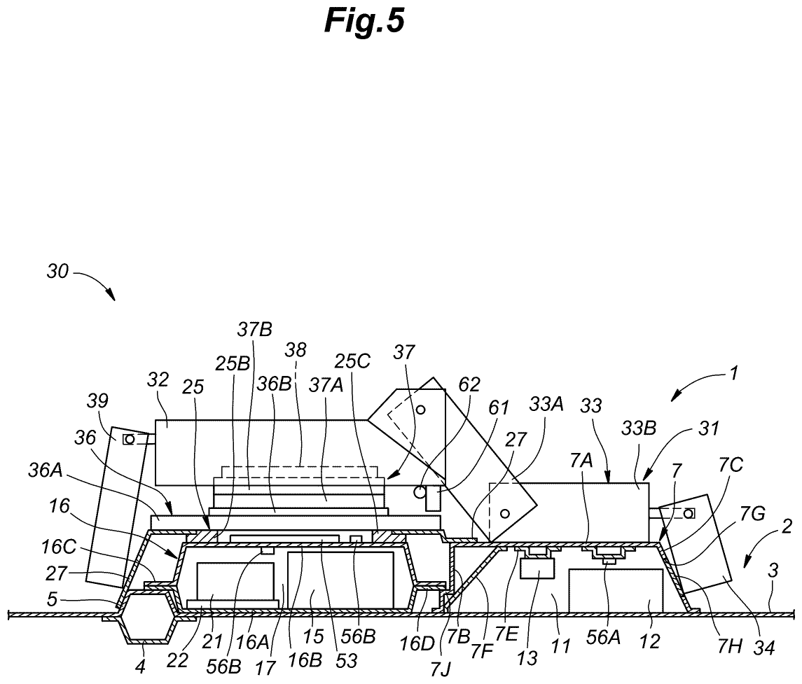

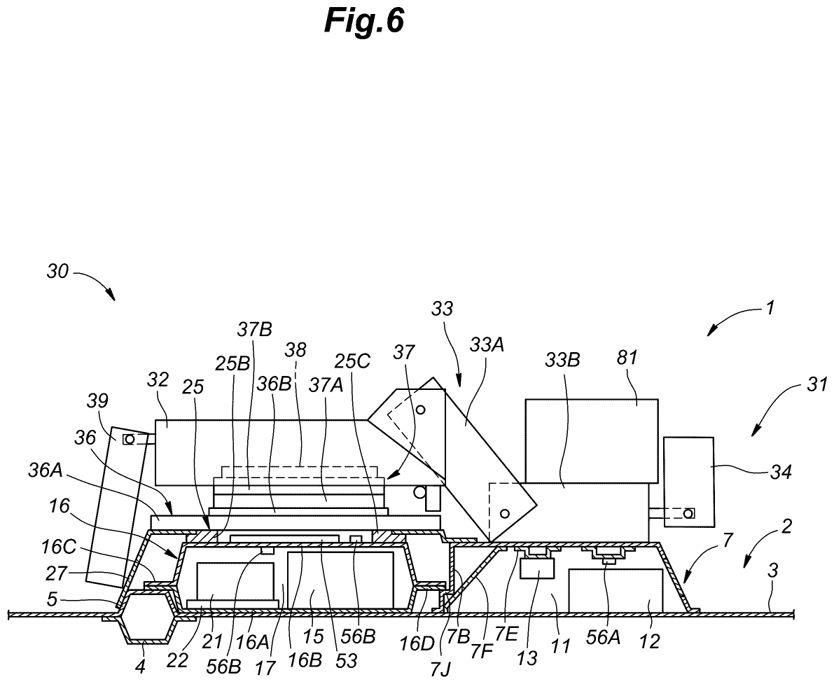

As shown in FIG. 5, the lower seat back 33A may extend rearward and downward from the rear end of the seat cushion 32 while the upper seat back 33B extends rearward from the lower seat back 33A along the upper wall 7A of the floor box 7. Further, the headrest 34 may extend rearward and downward from the upper seat back 33B along the rear wall 7C of the floor box 7. In this way, the seat back 33 and the headrest 34 can extend along the floor box 7. Further, as shown in FIG. 6, the headrest 34 may extend upward from the upper seat back 33B. Thereby, the headrest 34 and the lower seat back 33A can support the luggage 81 placed on the upper seat back 33B in the fore and aft direction.

According to the mounting structure 1 described above, the seat 30 is supported by the battery case 16 via the reinforcing structure 25, so that the seat 30 can be supported above the battery case 16 with good stability. Since the rigidity of the battery case 16 is improved by the reinforcing structure 25, the battery case 16 can support the seat 30 with good stability. Further, the battery and the reinforcing structure 25 can be efficiently positioned under the seat 30.

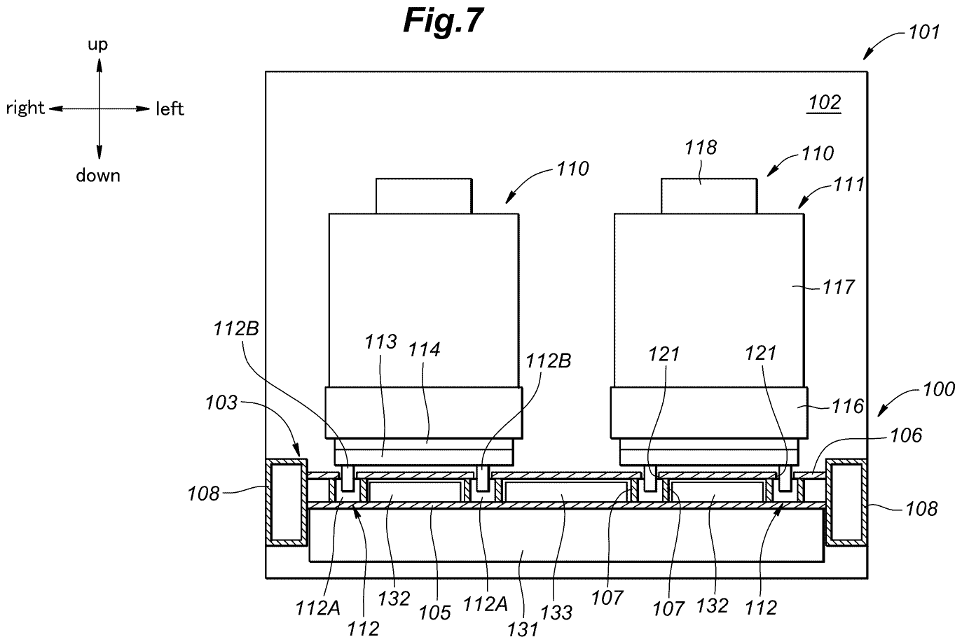

As shown in FIG. 7, in the mounting structure 100 according to another embodiment, the floor 103 that forms the bottom of the cabin 102 of the vehicle 101 may be formed by a first floor panel 105 and a second floor panel 106. The first floor panel 105 and the second floor panel 106 face vertically. The second floor panel 106 is positioned above the first floor panel 105 with a gap defined therebetween. A spacer 107 may be placed between the first floor panel 105 and the second floor panel 106. The first floor panel 105 is preferably formed of sheet steel. The second floor panel 106 is preferably formed of sheet steel or a resin material.

The lateral edges of the first floor panel 105 are connected to the left and right side sills 108, respectively. A plurality of cross members may be connected to the lower surface of the first floor panel 105. Each cross member preferably extends laterally and is connected to left and right side sills 108.

Each seat 110 is provided on the upper surface of the first floor panel 105. Each seat 110 has a seat main body 111, a slide device 112, a rotation device 113, and a height adjustment device 114. Each seat main body 111 includes a seat cushion 116, a seat back 117, and a headrest 118. These seats 110 may be front seats, middle seats, or rear seats.

Each slide device 112 includes a left and a right lower rail 112A provided on the upper surface of the first floor panel 105, and a left and a right upper rail 112B slidably supported by the corresponding lower rails 112A. Each lower rail 112A extends in the fore and aft direction. A plurality of slots 121 are formed in the second floor panel 106 and extend in the fore and aft direction along the lower rail 112A. Each slot 121 vertically passes through the second floor panel 106. Each upper rail 112B may be received by the corresponding slot 121 and protrude above the second floor panel 106. In this case, the edges of the second floor panel 106 defining each slot 121 may be supported by the upper edges of each lower rail 112A. In other words, each lower rail 112A may support the second floor panel 106 from below. In another embodiment, each lower rail 112A may pass through the slot 121 and protrude above the second floor panel 106.

The lower rails 112A of the front seat, middle seat, and rear seat on the left may be connected to each other in the fore and aft direction. Similarly, the lower rails 112A of the front seat, middle seat, and rear seat on the right may also be connected to each other in the fore and aft direction. Thereby, the movement range of each upper rail 112B can be increased.

The left and right upper rails 112B of each slide device 112 are preferably connected to a lower part of the rotation device 113. An upper part of the rotation device 113 is supported by the lower part thereof so as to be rotatable about an axis extending in the vertical direction. A thrust bearing may be provided between the lower and upper parts of the rotation device 113. The seat cushion 116 is provided on top of the rotation device 113 via the height adjustment device 114.

A first battery 131 is provided under the first floor panel 105. The first battery 131 may be supported by the lower surface of the first floor panel 105 and the cross member or the side sills 108 connected to the first floor panel 105.

A second battery 132 is provided between the first floor panel 105 and the second floor panel 106 and between the left and right lower rails 112A of each seat 110. Further, a third battery 133 is provided vertically between the first floor panel 105 and the second floor panel 106 and laterally between the right lower rail 112A of the left seat 110 and the left lower rail 112A of the right seat 110. By offsetting the right lower rail 112A of the left seat 110 to the left and the left lower rail 112A of the right seat 110 to the right, the space for accommodating the third battery 133 can be maximized.

In the above mounting structure 100, the second batteries 132 and the third battery 133 can be placed between the first floor panel 105 and the second floor panel 106. Since the second floor panel 106 is positioned above the second batteries 132 and the third battery 133, the second batteries 132 and the third battery 133 are not exposed to the cabin 102 of the vehicle. Furthermore, the second floor panel 106 allows the bottom of the vehicle cabin 102 to be simplified.

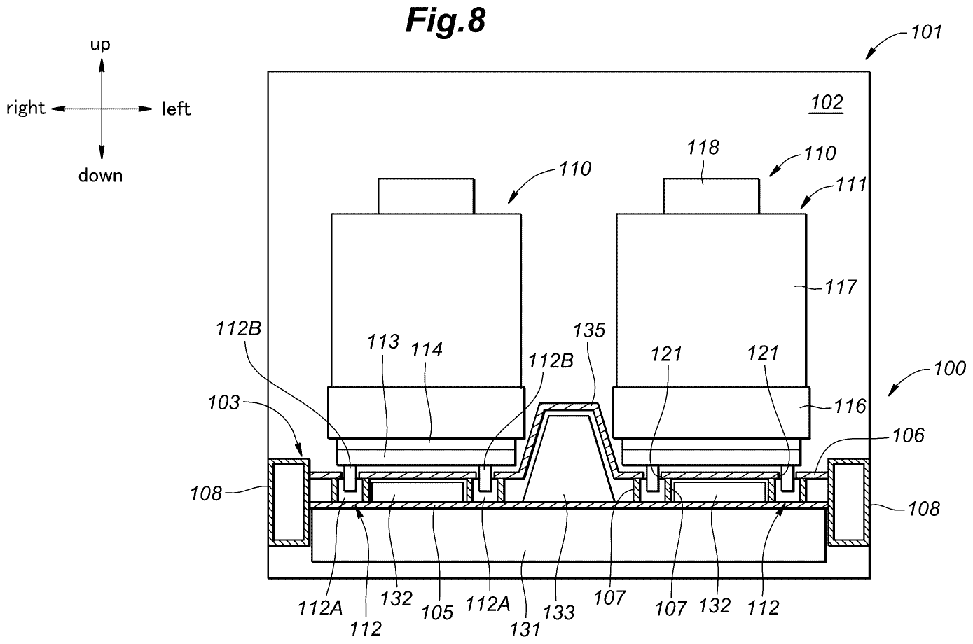

As shown in FIG. 8, a first tunnel portion 135 that bulges upward may be provided at a laterally central part of the second floor panel 106. The first tunnel portion 135 is positioned between the left and right seats 110 and extends in the fore and aft direction. The first tunnel portion 135 allows the space between the first floor panel 105 and the second floor panel 106 to be expanded upward. This makes it possible to place the third battery 133 inside the first tunnel portion 135 so that the size of the third battery 133 can be maximized.

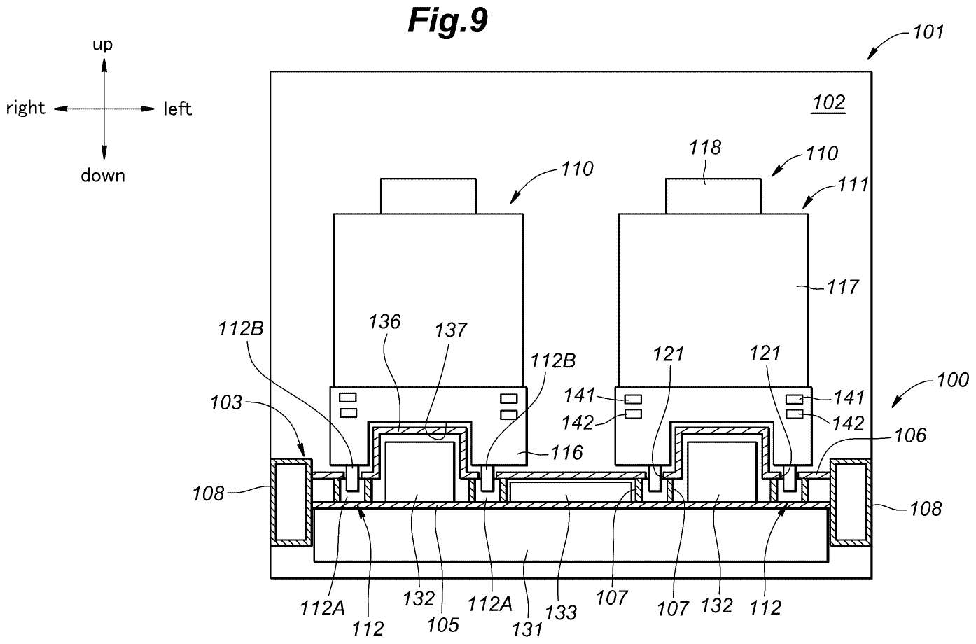

As shown in FIG. 9, a second tunnel portion 136 may be provided between the left and right lower rails 112A of each seat 110. In this case, a recess 137 that is recessed upward may be formed at a laterally central part of the bottom part of the seat cushion 116 of each seat 110. Further, the rotation device 113 and the height adjustment device 114 may be omitted, and the left and right upper rails 112B may be connected to the bottom of the seat cushion 116 for each seat 110. Each second tunnel portion 136 protrudes into the corresponding recess 137 and faces the seat cushion 116 with a gap defined therebetween. A second battery 132 is placed inside each second tunnel portion 136. The left and right tunnel portions allow the size of the second batteries 132 to be made larger. The left and right second tunnel portions 136 may extend in the fore and aft direction. In this case, it is preferable that each recess 137 extends in the fore and aft direction and reaches the front and rear ends of the seat cushion 116. Each second tunnel portion 136 and the corresponding second battery 132 may extend from under the front seat to under the rear seat.

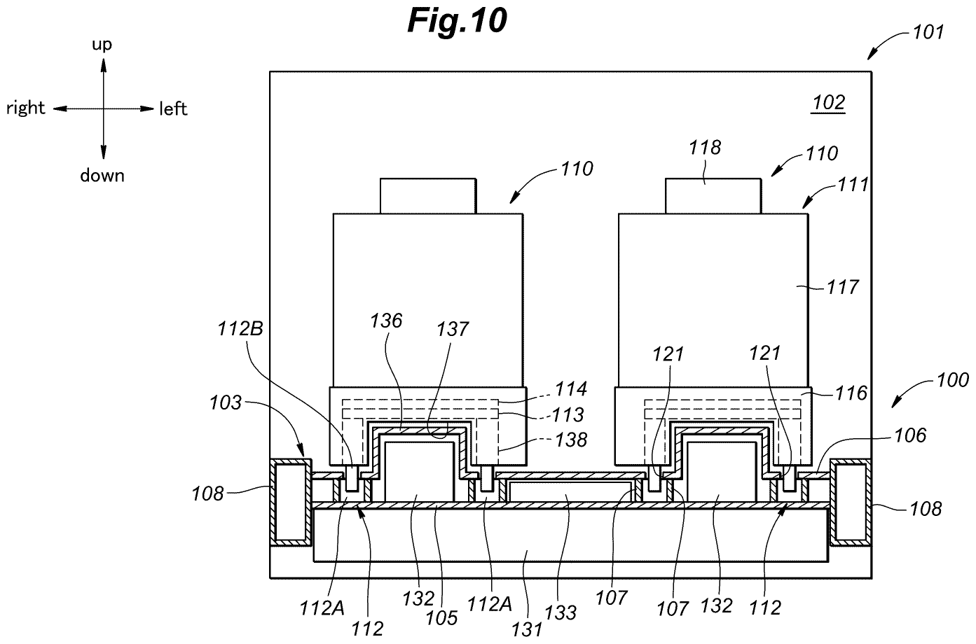

As shown in FIG. 10, a rotation device 113 and a height adjustment device 114 may be positioned inside the seat cushion 116 of each seat 110. When the seat cushion 116 is provided with a recess 137, the rotation device 113 is preferably positioned above the recess 137. In this case, it is preferable that the lower part of the rotation device 113 and the left and right upper rails 112B are connected to each other by brackets 138 that extend vertically.

As shown in FIG. 9, the seat cushion 116 may be provided with vibrating devices 141 and speakers 142 as notification devices. The vibrating devices 141 and the speakers 142 are preferably placed so as to avoid the recess 137. Further, a blower may be provided on each seat 110 so as to avoid the recess 137.

Some of the configurations of the above embodiments may be changed. For example, the floor box 7 may be omitted. In this case, the rear support legs 27 may be directly connected to the floor panel 3. Further, the rear fastening portion 16D of the battery case 16 may be directly connected to the floor panel 3. Further, the support legs 27 may be omitted and the slide device 36 may be supported only by the battery case 16.

As shown in JP2021-140989A and WO 2020/044717A, a vehicle is known in which a convex portion projecting upward is provided on the floor panel to place the battery unit inside the convex portion under the floor panel. There is a desire to appropriately arrange a seat cushion containing a foamed urethane pad and a foamed polypropylene pad described in JP2018-158096A on such a floor panel.

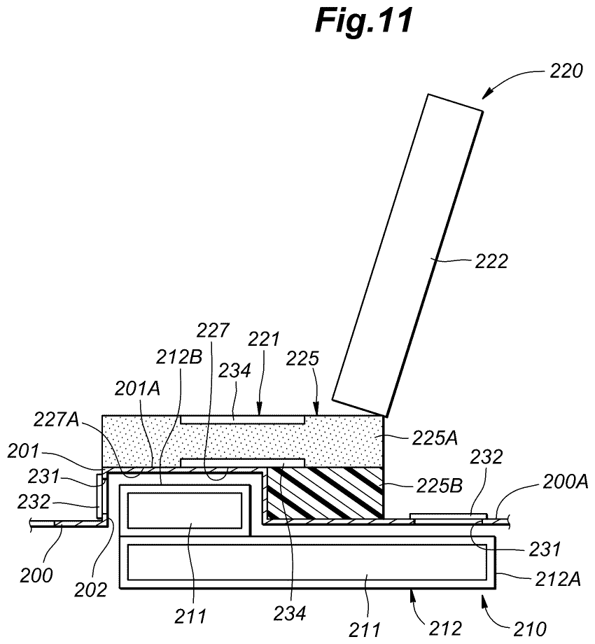

As shown in FIG. 11, a convex portion 201 protrudes upward from the upper surface 200A of the floor panel 200. A battery receiving portion 202 that opens downward is formed under the convex portion 201. The convex portion 201 is preferably formed into a substantially rectangular shape and extends in the fore and aft direction and the lateral direction. The upper surface 201A of the convex portion 201 preferably extends in the horizontal direction.

A battery unit 210 is placed under the floor panel 200. The battery unit 210 includes a plurality of batteries 211 and a battery case 212 that receives the batteries 211 therein. The battery case 212 has a lower case part 212A extending horizontally along the lower surface of the floor panel 200, and an upper case part 212B protruding upward from the upper surface of the lower case part 212A. The lower case part 212A is preferably formed into a flat rectangular parallelepiped box and extends in the fore and aft direction and the lateral direction. The upper case part 212B extends upward from a front end part of the lower case part 212A and extends in the lateral direction. The upper case part 212B protrudes into the battery receiving portion 202 located under the convex portion 201. Some of the batteries 211 are housed in the lower case part 212A, and the remaining batteries 211 are housed in the upper case part 212B. The battery case 212 is preferably connected to the left and right side sills and the cross members that support the floor panel 200. When viewed from a side, the lower case part 212A extends rearward from under the battery receiving portion 202.

A seat 220 is placed and fixed on the floor panel 200. The seat 220 includes a seat cushion 221 and a seat back 222. The seat cushion 221 is placed at least on the upper surface 201A of the convex portion 201. The seat cushion 221 includes a pad 225 and a skin material covering the pad 225. The frame of the seat cushion 221 may be omitted. Further, the frame of the seat cushion 221 may be provided around the pad 225 or inside the pad 225.

The pad 225 includes a first pad 225A provided at the top and a second pad 225B provided at the bottom of the first pad 225A. The second pad 225B is made of a harder material than the first pad 225A. The second pad 225B deforms less readily than the first pad 225A. The second pad 225B supports the first pad 225A from below. The second pad 225B may function as a frame structure. The first pad 225A and the second pad 225B are preferably bonded to each other. For example, the first pad 225A may be made of urethane foam, and the second pad 225B may be made of polypropylene foam.

The seat cushion 221 is provided with a recess 227 that receives the convex portion 201. The recess 227 is recessed upward from the lower surface of the seat cushion 221. The recess 227 is preferably provided at a front part of a laterally central part of the seat cushion 221. The recess 227 preferably reaches the front end of the seat cushion 221. The recess 227 is formed into a substantially rectangular parallelepiped shape. The upper end of the recess 227 is formed by a planar bottom surface 227A. The bottom surface 227A extends in the horizontal direction. The recess 227 is formed at least in the second pad 225B. The recess 227 may be formed in both the second pad 225B and the first pad 225A. In other words, the recess 227 may extend from the second pad 225B to the inside of the first pad 225A. Since the convex portion 201 fits into the recess 227, the seat cushion 221 can be placed in a stable manner on the floor panel 200 on which the convex portion 201 is formed.

The seat cushion 221 is placed on the floor panel 200, and the convex portion 201 projects into the recess 227. The upper surface 201A of the convex portion 201 contacts the bottom surface 227A of the recess 227. The lower surface of the seat cushion 221 contacts the upper surface 200A of the floor panel 200 at the rear part and the left and right end parts of the front part thereof. The lower part of the seat cushion 221 is preferably formed by the second pad 225B. The second pad 225B may be in contact with the upper surface 200A of the floor panel 200 in the vertical direction, and the first pad 225A may be in contact with the upper surface 201A of the convex portion 201. Since the second pad 225B is used in the thicker portion of the seat cushion 221, deformation of the seat cushion 221 is suppressed. The upper end of the second pad 225B and the lower end of the first pad 225A are preferably positioned at the same height as the upper surface 201A of the convex portion 201. The upper surface 201A of the convex portion 201 may be in contact with the lower end of the first pad 225A.

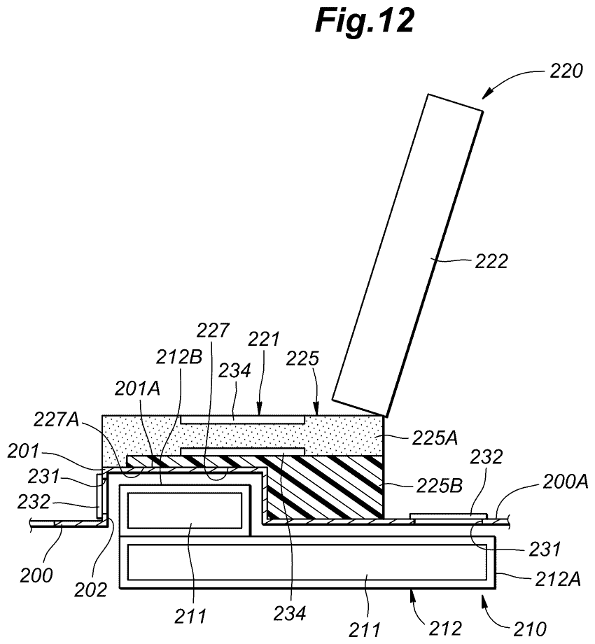

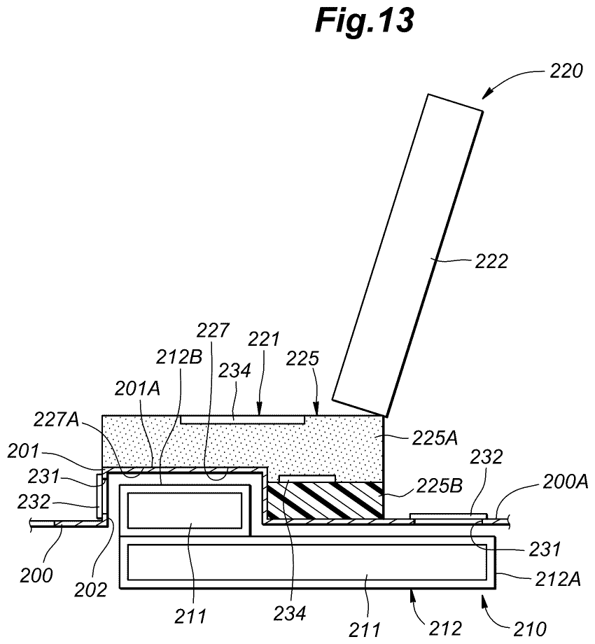

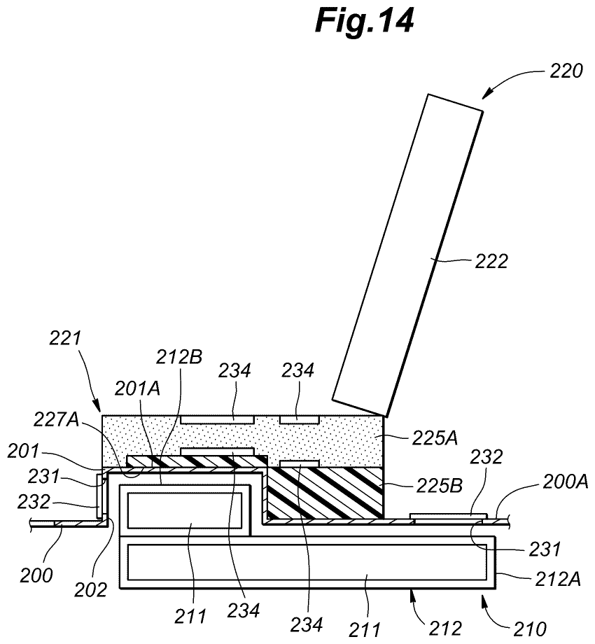

As shown in FIGS. 12 and 13, the upper end of the second pad 225B and the lower end of the first pad 225A may be positioned below or above the upper surface 201A of the convex portion 201. When the upper end of the second pad 225B and the lower end of the first pad 225A are positioned above the upper surface 201A of the convex portion 201, the upper surface 201A of the convex portion 201 may be in contact with the second pad 225B. The front part of the second pad 225B is placed on top of the convex portion 201, and the rear part of the second pad 225B is placed on the floor panel 200 behind the convex portion 201. As shown in FIGS. 12 and 14, the front and rear parts of the second pad 225B may be integrally formed or may be separated from each other. The thickness of the rear part of the second pad 225B is preferably greater than the thickness of the front part of the second pad 225B. The rear part of the seat cushion 221, which corresponds to the buttocks of the occupant, is more susceptible to the load of the occupant than the front part of the seat cushion 221. Since the thickness of the rear part of the second pad 225B is thicker than the thickness of the front part of the second pad 225B, the seat cushion 221 can efficiently resist the load of the occupant. Further, the seat cushion 221 can provide a comfortable seating feeling to the occupant. Further, the upper surface of the second pad 225B may be offset downward from the upper surface of the front part of the second pad 225B.

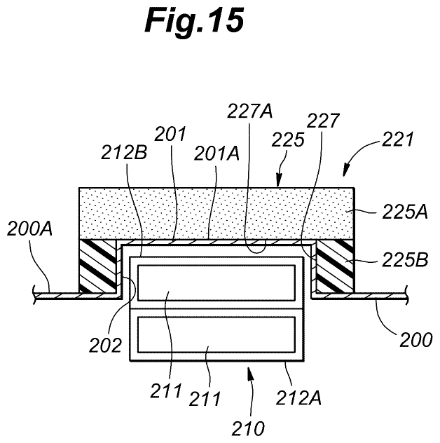

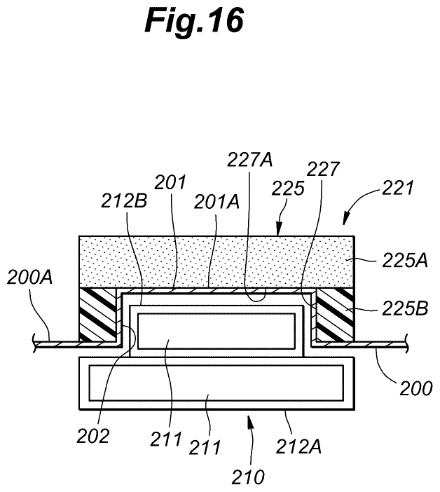

As shown in FIGS. 15 and 16, the second pad 225B may be positioned on the rear, left, and right sides of the convex portion 201.

As shown in FIG. 15, when the lateral widths of the lower case part 212A and the upper case part 212B are the same, the part of the second pad 225B located at the front end part of the seat cushion 221 may be positioned so as not to overlap with the lower case part 212A when viewed from above. On the other hand, as shown in FIG. 16, when the lateral width of the lower case part 212A is larger than the lateral width of the upper case part 212B, the part of the second pad 225B located at the front end part of the seat cushion 221 may be located so as to overlap with the lower case part 212A when viewed from above.

As shown in FIG. 11, a plurality of maintenance holes 231 may be formed in the floor panel 200. Each maintenance hole 231 passes through the floor panel 200. A removable plug 232 may be fitted to each maintenance hole 231. One of the maintenance holes 231 is preferably provided behind the seat cushion 221 and opposite the battery case 212. Further, one of the maintenance holes 231 is preferably formed in the front wall of the convex portion 201. In this way, each maintenance hole 231 is preferably placed at a position avoiding the seat cushion 221. This prevents each maintenance hole 231 from being blocked by the seat cushion 221. An operator can access the battery unit 210 from the vehicle cabin through the maintenance hole 231.

The seat cushion 221 may be provided with a plurality of switches 234. Each switch 234 is preferably a membrane switch or a pressure sensor in a sheet form. One of the switches 234 may be turned on and off in response to the load of the occupant seated on the seat 220. The signal from the switch 234 may be used, for example, as a seat belt reminder.

The switches 234 may be provided on the upper and lower surfaces of the first pad 225A. Some of the switches 234 may be positioned between the lower surface of the first pad 225A and the convex portion 201. In particular, when viewed from above, some of the switches 234 may be arranged at positions overlapping with the convex portion 201 and the upper case part 212B. Further, some of the switches 234 may be positioned so as not to overlap with the second pad 225B when viewed from above. Further, some of the switches 234 may be positioned between the lower surface of the first pad 225A and the upper surface of the second pad 225B. In other words, some of the switches 234 may be positioned so as to overlap with the second pads 225B when viewed from above.

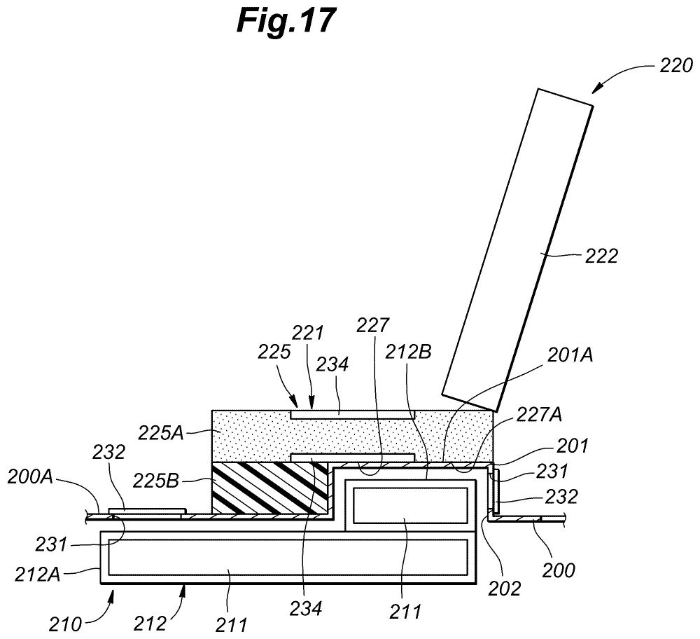

As shown in FIG. 17, the recess 227 and the convex portion 201 may be positioned so as to correspond to a rear part of the seat cushion 221. In this case, the upper case part 212B is preferably positioned behind the lower case part 212A. The maintenance holes 231 are preferably formed in front of the seat cushion 221 and the rear wall of the convex portion 201.

JP2015-229440 discloses a heater control device that switches between a hot-air heater that blows warm air into the vehicle cabin by using the heat from the engine cooling water and an electric heater that operates with the electric power supplied from the battery depending on the remaining battery power. In such a heater control device, it is desired to reduce the power consumption of the battery while maintaining the temperature comfort of the occupant.

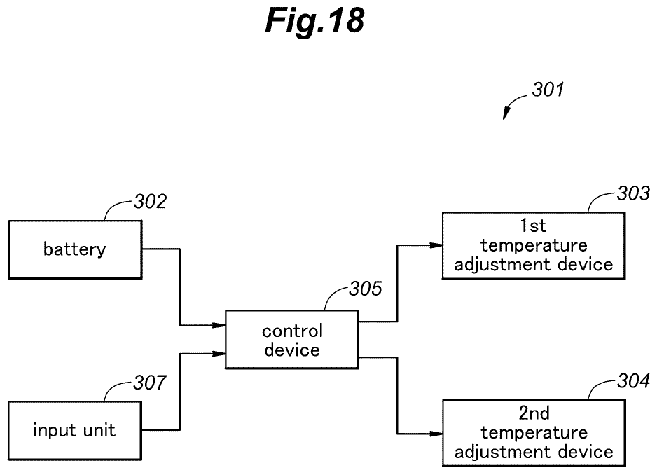

As shown in FIG. 18, a vehicle 301 includes a battery 302, a first temperature adjustment device 303, a second temperature adjustment device 304, and a control device 305. The battery 302 supplies electric power to various electric devices of the vehicle 301. The electric devices may include a driving motor for driving the vehicle 301.

The first temperature adjustment device 303 is an air conditioning device provided in the vehicle body. The first temperature adjustment device 303 receives power from the battery 302, heats or cools air to adjust the temperature thereof, and discharges the temperature-adjusted air from the air outlet. The first temperature adjustment device 303 may include, for example, a compressor, an evaporator, a condenser and a blower. The air outlet is preferably provided in the instrument panel or the roof. In other words, the air outlet is positioned some distance away from the occupant seated on the seat.

The second temperature adjustment device 304 is provided in the seat on which a passenger is seated. The second temperature adjustment device 304 includes, for example, at least one of a seat heater in a sheet form and a seat blower. The heater is provided in the seat in a sheet form, and includes a heating wire that receives power from the battery 302 and raises the temperature thereof. The blower device includes an air passage provided in the seat, a blower provided in the air passage and a temperature control unit. One end of the air passage is connected to an air blowing opening provided on the seating surface of the seat. A blower blows air into the air blowing passage. The temperature control unit preferably includes at least one of a heater core that receives electric power from the battery 302 to raise the temperature thereof, and a Peltier device that receives electric power from the battery 302 and lowers the temperature thereof.

The second temperature adjustment device 304 is configured to consume less power than the first temperature adjustment device 303. The first temperature adjustment device 303 adjusts the temperature of the entire vehicle cabin, while the second temperature adjustment device 304 locally adjusts the temperature around the passenger seated on the seat.

The control device 305 includes a processor such as a CPU, nonvolatile memory (ROM), volatile memory (RAM), and the like. The control device 305 controls the first temperature adjustment device 303 and the second temperature adjustment device 304 by causing the processor to execute arithmetic processing in accordance with a program stored in the nonvolatile memory. The control device 305 is connected to an input unit 307 operated by the passenger. The input unit 307 may comprise a switch, a touch panel, a touch panel display, or the like.

The input unit 307 outputs signals corresponding to the target output of the first temperature adjustment device 303 and the target output of the second temperature adjustment device 304 to the control device 305, for example, in response to an operation by the occupant. In another example, the input unit 307 may supply signals corresponding to the combined target output of the first temperature adjustment device 303 and the target output of the second temperature adjustment device 304 and the target usage ratio between the first temperature adjustment device 303 and the second temperature adjustment device 304 to the control device 305. In yet another embodiment, the input unit 307 may output a signal corresponding to the target temperature to the control device 305.

The input unit 307 forwards, for example, the target output of the first temperature adjustment device 303 and the target output of the second temperature adjustment device 304 to the control device 305. The target outputs are preferably each set to a value between 0% and 100%.

The control device 305 is connected to the battery 302 and obtains the SOC (State of Charge) of the battery 302.

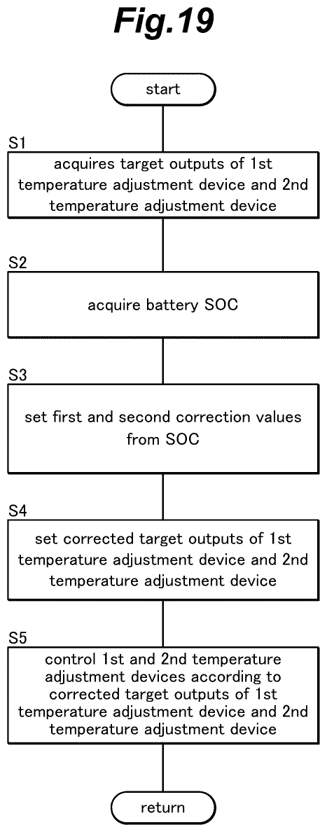

The temperature adjustment control executed by the control device 305 will be discussed in the following. The control device 305 executes the temperature adjustment control shown in FIG. 19 at predetermined intervals. The control device 305 first acquires the target output of the first temperature adjustment device 303 and the target output of the second temperature adjustment device 304 based on the signal from the input unit 307 (S1).

Next, the control device 305 acquires the SOC of the battery 302 (S2). Next, the control device 305 sets a first correction value which is a correction value for the first temperature adjustment device 303 and a second correction value which is a correction value for the second temperature adjustment device 304 based on the SOC (S3). For example, the first correction value is an output to be added to the target output of the first temperature adjustment device 303, and is preferably set to a value between −100% and 100%. Similarly, the second correction value is an output to be added to the target output of the second temperature adjustment device 304, and is preferably set to a value between 100%.

The first correction value is set to decrease as the SOC decreases. On the other hand, the second correction value is set to increase as the SOC decreases. The control device 305 preferably sets the first correction value based on the SOC by using a map that defines the relationship between the SOC and the first correction value. Similarly, the control device 305 may set the second correction value based on the SOC by using a map that defines the relationship between the SOC and the second correction value.

Next, the control device 305 sets the corrected target output of the first temperature adjustment device 303 by adding the first correction value to the target output of the first temperature adjustment device 303, and sets the corrected target output of the second temperature adjustment device 304 by adding the second correction value to the target output of the second temperature adjustment device 304 (S4). At this time, the control device 305 sets the corrected target output of the first temperature adjustment device 303 to 0% when the added value of the target output of the first temperature adjustment device 303 and the first correction value is 0% or less, and sets the corrected target output of the first temperature adjustment device 303 to 100% when the added value of the target output of the first temperature adjustment device 303 and the first correction value is 100% or more. Similarly, the control device 305 sets the corrected target output of the second temperature adjustment device 304 to 0% when the added value of the target output of the second temperature adjustment device 304 and the second correction value is 0% or less, and sets the corrected target output of the second temperature adjustment device 304 to 100% when the added value of the target output of the second temperature adjustment device 304 and the second correction value is 100% or more.

Next, the control device 305 controls the first temperature adjustment device 303 based on the corrected target output of the first temperature adjustment device 303, and controls the second temperature adjustment device 304 based on the corrected target output of the second temperature adjustment device 304 (S5).

Owing to the temperature adjustment control executed by the control device 305, the output of the first temperature adjustment device 303 is reduced and the output of the second temperature adjustment device 304 is increased in accordance with the decrease in SCO. Thereby, the total power consumption of the first temperature adjustment device 303 and the second temperature adjustment device 304 can be reduced. Further, since the second temperature adjustment device 304 locally adjusts the temperature in the vicinity of the occupant seated on the seat, temperature-related comfort for the occupant can be maintained.

For example, when the SOC is equal to or greater than a first determination value, the first correction value and the second correction value may be set to zero. The first determination value is preferably 50%, for example. Thereby, the first temperature adjustment device 303 and the second temperature adjustment device 304 are controlled based on the target output of the first temperature adjustment device 303 and the target output of the second temperature adjustment device 304 set by the occupant. In other words, the first temperature adjustment device 303 and the second temperature adjustment device 304 are controlled based on the occupant's intention.

Moreover, when the SOC is equal to or greater than the second determination value and less than the first determination value, a negative value may be set to the first correction value and a positive value may be set to the second correction value. The second determination value may be set to a value lower than the first determination value, and may be set to 30%, for example. As a result, the actual output of the first temperature adjustment device 303 becomes lower than the target output of the first temperature adjustment device 303 set by the occupant, and the actual output of the second temperature adjustment device 304 becomes higher than the target output of the second temperature adjustment device 304 set by the occupant. As a result, even if the target output of the second temperature adjustment device 304 set by the occupant is 0%, the second temperature adjustment device 304 starts operating.

Moreover, when the SOC is less than the second determination value, it is preferable that a negative value is set to the first correction value and a positive value is set to the second correction value. Thereby, the actual output of the first temperature adjustment device 303 is further reduced, and the actual output of the second temperature adjustment device 304 is further increased. At this time, the first correction value may be set to-100% and the first temperature adjustment device 303 may be stopped.

The number and magnitudes of the above-mentioned SOC determination values may be set freely. The control device 305 may stop the temperature adjustment control according to the occupant's selection. Further, the control device 305 may inquire the occupant if temperature adjustment control is to be executed when the SOC value reaches a certain determination value. For example, the control device 305 may inquire the occupant by speech issuing from a speaker, or may use a display to make an inquiry to the occupant through a screen display. When a decrease in the SOC is anticipated, the control device 305 may inquire the occupant if the temperature adjustment control should be started, or may start the temperature adjustment control without inquiring the occupant. The control device 305 may predict a decrease in the SOC based on the outside temperature, for example. Further, the control device 305 may predict a decrease in the SOC based on the gradient on the travel route. Further, the control device 305 may stop the temperature adjustment control when there is a charging station near the vehicle 301.

LIST OF REFERENCE NUMERALS

| | |
|---|---|
| 1: mounting structure | 2: floor |
| 7: floor box | 11: floor housing chamber |
| 12: first battery | 15: second battery |
| 16: battery case | 17: case housing chamber |
| 25: reinforcement structure | 25A: first member |
| 25B: second member | 25C: third member |
| 27: support leg | 30: seat |
| 36: slide device | 36A: lower rail |
| 36B: upper rail | 37: rotation device |
| 37A: base plate | 37B: rotating plate |
| 38: height adjustment device | 53: electronic control device |

1. A vehicle seat mounting structure, comprising:
a floor;
a battery case provided on the floor and housing a battery;
a seat connected to the floor via a plurality of support legs and positioned above the battery case; and
a reinforcing structure provided on a top side of the battery case and connected to the seat.

2. The vehicle seat mounting structure according to claim 1, wherein the reinforcing structure includes a plurality of reinforcing members extending along an upper surface of the battery case and connected to one another, the reinforcing members having a frame structure when viewed from above.

3. The vehicle seat mounting structure according to claim 2, wherein the reinforcing members include a left and a right first member that extend in a fore and aft direction, a second member that extends in a lateral direction and is connected between front ends of the left and right first members, and a third member that extends in the lateral direction and is connected between the rear ends of the left and right first members, and the front and rear ends of the first members are connected to the seat.

4. The vehicle seat mounting structure according to claim 2, wherein at least a part of the battery overlaps with the reinforcing structure when viewed from above.

5. The vehicle seat mounting structure according to claim 2, wherein the support legs are connected to the seat and the reinforcing structure.

6. The vehicle seat mounting structure according to claim 2, wherein the seat includes a seat main body and a slide device provided under the seat main body, and the reinforcing structure and the support legs are connected to the slide device.

7. The vehicle seat mounting structure according to claim 6, wherein the seat includes a rotation device interposed between the seat main body and the slide device, and at least a part of the rotation device overlaps with the reinforcing structure when viewed from above.

8. The vehicle seat mounting structure according to claim 2, wherein an electronic control device is provided inside the reinforcing structure when viewed from above.

9. The vehicle seat mounting structure according to claim 8, wherein the electronic control device is positioned on the upper surface of the battery case.

10. The vehicle seat mounting structure according to claim 9, wherein the battery at least partly overlaps with the electronic control device when viewed from above.

11. A method for fabricating a vehicle seat mounting structure which includes a floor, a battery case provided on the floor and housing a battery, and a seat connected to the floor via a plurality of support legs and positioned above the battery case, the method comprising the steps of:
providing a reinforcing structure on a top side of the battery case, and
connecting the reinforcing structure to the seat.

12. The method according to claim 11, wherein the reinforcing structure includes a plurality of reinforcing members extending along an upper surface of the battery case and connected to one another, the reinforcing members having a frame structure when viewed from above.

13. The method according to claim 12, wherein the reinforcing members include a left and a right first member that extend in a fore and aft direction, a second member that extends in a lateral direction and is connected between front ends of the left and right first members, and a third member that extends in the lateral direction and is connected between the rear ends of the left and right first members, and the front and rear ends of the first members are connected to the seat.

14. The method according to claim 12, wherein at least a part of the battery overlaps with the reinforcing structure when viewed from above.

15. The method according to claim 12, wherein the support legs are connected to the seat and the reinforcing structure.

16. The method according to claim 12, wherein the seat includes a seat main body and a slide device provided under the seat main body, and the reinforcing structure and the support legs are connected to the slide device.

17. The method according to claim 16, wherein the seat includes a rotation device interposed between the seat main body and the slide device, and at least a part of the rotation device overlaps with the reinforcing structure when viewed from above.

18. The method according to claim 12, wherein an electronic control device is provided inside the reinforcing structure when viewed from above.

19. The method according to claim 18, wherein the electronic control device is positioned on the upper surface of the battery case.

20. The method according to claim 19, wherein the battery at least partly overlaps with the electronic control device when viewed from above.
